(19) United States
(12) Patent Application Publication
(10) Pub. No.: US 2024/0276536 A1
(43) Pub. Date: Aug. 15, 2024

(54) USER EQUIPMENT AND BASE STATION IN WIRELESS COMMUNICATION SYSTEM AND METHODS PERFORMED THEREBY

(71) Applicant: SAMSUNG ELECTRONICS CO., LTD., Suwon-si (KR)

(72) Inventors: Jingxing FU, Beijing (CN); Feifei SUN, Beijing (CN); Zhe CHEN, Beijing (CN)

(21) Appl. No.: 18/437,157

(22) Filed: Feb. 8, 2024

(30) Foreign Application Priority Data
Feb. 10, 2023 (CN) 202310149700.6

(51) Int. Cl. H04W 72/542; H04L 1/1812; H04L 5/00; H04W 52/24; H04W 72/1273

(52) U.S. Cl. CPC H04W 72/542; H04L 1/1812; H04L 5/0055; H04W 52/241; H04W 72/1273

(57) ABSTRACT

The disclosure relates to a 5G or 6G communication system for supporting a higher data transmission rate. The present disclosure discloses a user equipment (UE) and a base station in a wireless communication system and methods performed the user equipment and the base station. A method performed by a user equipment in a wireless communication system may comprise: receiving a first mapping relationship, wherein the first mapping relationship comprises a mapping relationship between first information and a channel quality indicator (CQI) table for identifying a CQI, and the first information is information related to a power control offset (powerControlOffset); receiving first indication information; identifying a CQI table according to the first indication information and the first mapping relationship; and identifying a CQI according to the identified CQI table.

### CROSS-REFERENCE TO RELATED APPLICATION

This application claims priority to Chinese Patent Application 202310149700.6 filed on Feb. 10, 2023, in the China National Intellectual Property Office, the disclosure of which is incorporated by reference herein in its entirety.

### BACKGROUND

### 1. Field

The present disclosure relates to the technical field of wireless communication, and more specifically to a user equipment and a base station in a wireless communication system and methods performed by the user equipment and the base station.

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

According to an aspect of the present disclosure, a user equipment (UE) calculates a channel quality indicator (hereinafter referred to as CQI) based on a power control offset (powerControlOffset) and a CQI table. In order to be able to dynamically adjust the powerControlOffset, an enhancement to indicate the powerControlOffset and/or CQI table used when the CQI is calculated is used.

To this end, a method performed by a user equipment (UE) in a wireless communication system according to an embodiment may comprise: receiving a first mapping relationship, wherein the first mapping relationship comprises a mapping relationship between first information and a CQI table for calculating a CQI, and the first information is information related to a power control offset (powerControlOffset); receiving first indication information; determining the CQI table according to the first indication information and the first mapping relationship; and calculating the CQI according to the determined CQI table.

According to this embodiment, based on the mapping relationship between the information related to the power control offset and the CQI table, the power control offset and CQI table used when the CQI is calculated are determined according to the received first indication information, without requiring additional signaling (e.g., higher-layer signaling cqi-Table). Thus, the power control offset and the used CQI table can be flexibly indicated.

Alternatively, the first indication information is received through physical-layer signaling or medium-access-control-layer signaling.

The power control offset (powerControlOffset) represents an assumed power offset between a physical downlink shared channel (PDSCH) and a channel state information-reference signal (CSI-RS) resource. Alternatively, the user equipment may calculate the CQI according to the determined CQI table and the power control offset.

Alternatively, the first mapping relationship comprises a mapping relationship between the power control offset and the CQI table. Here, the determining of the CQI table according to the first indication information and the first mapping relationship comprises: determining a power control offset indicated by the first indication information; and determining a corresponding CQI table according to the determined power control offset and the first mapping relationship.

Alternatively, the first mapping relationship comprises a mapping relationship between a power control offset difference range and the CQI table. Here, the method further comprises: receiving information related to a reference power control offset. Here, the determining of the CQI table according to the first indication information and the first mapping relationship comprises: determining a difference between a power control offset indicated by the first indication information and the reference power control offset; and determining a corresponding CQI table according to the determined difference and the first mapping relationship.

Alternatively, the receiving of the information related to the reference power control offset may comprise: receiving the information related to the reference power control offset through higher-layer signaling.

Alternatively, the receiving of the information related to the reference power control offset may comprise: receiving information related to a plurality of power control offsets and indication information through higher-layer signaling, the indication information being used to indicate the reference power control offset in the plurality of power control offsets.

Alternatively, the receiving of the information related to the reference power control offset may comprise: receiving information related to a plurality of power control offsets through higher-layer signaling, wherein the reference power control offset is determined from the plurality of power control offsets based on a preset rule.

Alternatively, the first mapping relationship comprises a mapping relationship among indication information, the power control offset to the CQI table. Here, the determining of the CQI table according to the first indication information and the first mapping relationship comprises: determining a power control offset and a CQI table corresponding to the first indication information according to the first indication information and the first mapping relationship.

According to another aspect of the present disclosure, the user equipment (UE) determines a specific modulation and coding scheme table when determining the parameters of a physical downlink shared channel. To this end, a method performed by a user equipment (UE) in a wireless communication system according to an embodiment may comprise: receiving a second mapping relationship, wherein the second mapping relationship comprises a mapping relationship between second information and a modulation and coding scheme (MCS) table, and the second information is information related to a power control offset (powerControlOffset); receiving second indication information; determining the MCS table according to the second indication information and the second mapping relationship; and determining MCS parameters of a physical downlink shared channel (PDSCH) according to the determined MCS table.

According to this embodiment, through the mapping relationship between the information related to the power control offset and the MCS table, the UE may dynamically select the MCS table according to the received second indication information to determine the MCS parameters of the PDSCH, without requiring additional signaling (e.g., higher-layer signaling mcs-Table).

Alternatively, the second indication information is received through physical-layer signaling or medium-access-control-layer signaling.

Alternatively, the second mapping relationship comprises a mapping relationship between the power control offset and the MCS table. Here, the determining of the MCS table according to the second indication information and the second mapping relationship comprises: determining a power control offset indicated by the second indication information; and determining a corresponding MCS table according to the determined power control offset and the second mapping relationship.

Alternatively, the second mapping relationship comprises a mapping relationship between a power control offset difference range and the MCS table. Here, the method further comprises: receiving information related to a reference power control offset. Here, the determining of the MCS table according to the second indication information and the second mapping relationship comprises: determining a difference between the power control offset indicated by the second indication information and the reference power control offset; and determining a corresponding MCS table according to the determined difference and the second mapping relationship.

Alternatively, the receiving of the information related to the reference power control offset comprises: receiving the information related to the reference power control offset through higher-layer signaling.

Alternatively, the receiving of the information related to the reference power control offset comprises: receiving information related to a plurality of power control offsets and indication information through higher-layer signaling, the indication information being used to indicate the reference power control offset in the plurality of power control offsets.

Alternatively, the receiving of the information related to the reference power control offset comprises: receiving information related to a plurality of power control offsets through higher-layer signaling, wherein the reference power control offset is determined from the plurality of power control offsets based on a preset rule.

Alternatively, the second mapping relationship comprises a mapping relationship among indication information, the power control offset and the MCS table. Here, the determining of the MCS table according to the second indication information and the second mapping relationship comprises: determining the power control offset and the MCS table corresponding to the second indication information according to the second indication information and the second mapping relationship.

According to another aspect of the present disclosure, when receiving the information related to a power control offset from a base station gNB through physical-layer signaling or medium-access-control-layer signaling, the user equipment (UE) should ensure that the gNB and the UE have the same the understandings on the power control offset. To this end, a method performed by a user equipment (UE) in a wireless communication system according to an embodiment may comprise: receiving information related to a power control offset (powerControlOffset) through physical-layer signaling or medium-access-control-layer signaling; and transmitting, to a base station, third indication information related to a power control offset used by the UE to calculate a channel quality indicator (CQI).

Alternatively, the third indication information is transmitted through signaling of reporting, by the UE, CQI-related information to the base station.

Alternatively, the third indication information is used to indicate whether the power control offset used by the UE to calculate the CQI is changed, and the third indication information is transmitted through a signaling for reporting the CQI-related information for first time after the power control offset used by the UE to calculate the CQI is changed, or the third indication information is transmitted through signaling for reporting the CQI-related information each time.

Alternatively, the third indication information is used to indicate the power control offset used by the UE to calculate the CQI, and the third indication information is transmitted through the signaling for reporting the CQI-related information each time.

Alternatively, the information related to the power control offset is received through downlink control information (DCI), and the third indication information is transmitted to the base station through a first hybrid automatic repeat request acknowledgement (HARQ-ACK), the first HARQ-ACK being, by the UE, for the DCI for transmitting the power control offset.

Alternatively, a first physical uplink control channel (PUCCH) resource for transmitting the first HARQ-ACK is obtained through higher-layer signaling. Here, the first HARQ-ACK is transmitted on the first PUCCH resource.

Alternatively, a second PUCCH resource for transmitting a second HARQ-ACK of a physical downlink shared channel (PDSCH) is obtained through higher-layer signaling. Here, the first HARQ-ACK is transmitted on the second PUCCH resource.

Alternatively, a second PUCCH resource for transmitting a second HARQ-ACK of a physical downlink shared channel (PDSCH) is obtained through higher-layer signaling. When a first PUCCH resource for transmitting the first HARQ-ACK is obtained through the higher-layer signaling, the first HARQ-ACK is transmitted on the first PUCCH resource. When the first PUCCH resource for transmitting the first HARQ-ACK is not obtained, the first HARQ-ACK is transmitted the second PUCCH resource.

Alternatively, if the first HARQ-ACK is transmitted on the second PUCCH resource, the first HARQ-ACK is arranged before or behind a sequence formed by arranging a HARQ-ACK of a PDSCH scheduled by the DCI and a HARQ-ACK of a semi-persistent (SPS) PDSCH, to form a total HARQ-ACK sequence, and the total HARQ-ACK sequence is transmitted on the second PUCCH resource.

Alternatively, if the first HARQ-ACK is transmitted on the second PUCCH resource, the HARQ-ACK of the semi-persistent (SPS) PDSCH is arranged behind a sequence formed by arranging the HARQ-ACK of the PDSCH scheduled by the DCI and the first HARQ-ACK, to form a total HARQ-ACK sequence, and the total HARQ-ACK sequence is transmitted on the second PUCCH resource.

According to another aspect of the present disclosure, a user equipment (UE) in a wireless communication system according to an implementation may comprise: a transceiver; and a processor, coupled to the transceiver and configured to perform the method performed by the user equipment (UE) in the wireless communication system according to any one of the above implementations.

According to another aspect of the present disclosure, a method performed by a base station gNB in a wireless communication system may comprise: transmitting a first mapping relationship to a user equipment (UE), wherein the first mapping relationship comprises a mapping relationship between first information and a CQI table for calculating a CQI, and the first information is information related to a power control offset (powerControlOffset); transmitting first indication information to the UE; and receiving CQI-related information from the UE, the CQI-related information being calculated and obtained based on a CQI table determined according to the first indication information and the first mapping relationship.

According to another aspect of the present disclosure, a method performed by a base station gNB in a wireless communication system may comprise: transmitting a second mapping relationship to a user equipment (UE), wherein the second mapping relationship comprises a mapping relationship between second information and a modulation and coding scheme (MCS) table, and the second information is information related to a power control offset (powerControlOffset); and transmitting second indication information to the UE, wherein MCS parameters of a physical downlink shared channel (PDSCH) are determined based on an MCS table determined according to the second indication information and the second mapping relationship.

According to another aspect of the present disclosure, a method performed by a base station gNB in a wireless communication system may comprise: transmitting information related to a power control offset (powerControlOffset) to a user equipment (UE) through physical-layer signaling or medium-access-control-layer signaling; and receiving, from the UE, third indication information related to a power control offset used by the UE to calculate a channel quality indicator (CQI).

According to another aspect of the present disclosure, a base station gNB in a wireless communication system may comprise: a transceiver; and a processor coupled to the transceiver and configured to perform the method performed by the base station gNB in the wireless communication system according to any one of the above implementations.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and additional aspects and advantages of the present disclosure will become more apparent and easier to understand through the following description in combination with the accompanying drawings, in which like reference numerals represent like parts:

FIG. 1 illustrates a schematic diagram of various compositions and structures of a wireless network according to embodiments of the present disclosure;

FIG. 2A illustrates an exemplary wireless transmission path according to the present disclosure;

FIG. 2B illustrates an exemplary wireless reception path according to the present disclosure;

FIG. 3A illustrates a block diagram of a composition and structure of a user equipment according to an embodiment of the present disclosure;

FIG. 3B illustrates a block diagram of a composition and structure of a base station according to an embodiment of the present disclosure;

FIG. 4 illustrates a schematic flow diagram of a method performed by a user equipment in a wireless communication system according to an embodiment of the present disclosure;

FIG. 5 illustrates a schematic flow diagram of an embodiment of the method performed by the user equipment in the wireless communication system according to an embodiment of the present disclosure;

FIG. 6 illustrates a schematic flow diagram of another embodiment of the method performed by the user equipment in the wireless communication system according to an embodiment of the present disclosure;

FIG. 7 illustrates a schematic flow diagram of another embodiment of the method performed by the user equipment in the wireless communication system according to an embodiment of the present disclosure;

FIG. 8 illustrates a schematic flow diagram of a method performed by a user equipment in a wireless communication system according to an other embodiment of the present disclosure;

FIG. 9 illustrates a schematic flow diagram of another embodiment of the method performed by the user equipment in the wireless communication system according to an embodiment of the present disclosure;

FIG. 10 illustrates a schematic flow diagram of another embodiment of the method performed by the user equipment in the wireless communication system according to an embodiment of the present disclosure;

FIG. 11 illustrates a schematic flow diagram of another embodiment of the method performed by the user equipment in the wireless communication system according to an embodiment of the present disclosure; and

FIG. 12 illustrates a schematic flow diagram of a method performed by a user equipment in a wireless communication system according to an other embodiment of the present disclosure.

### DETAILED DESCRIPTION OF EMBODIMENTS

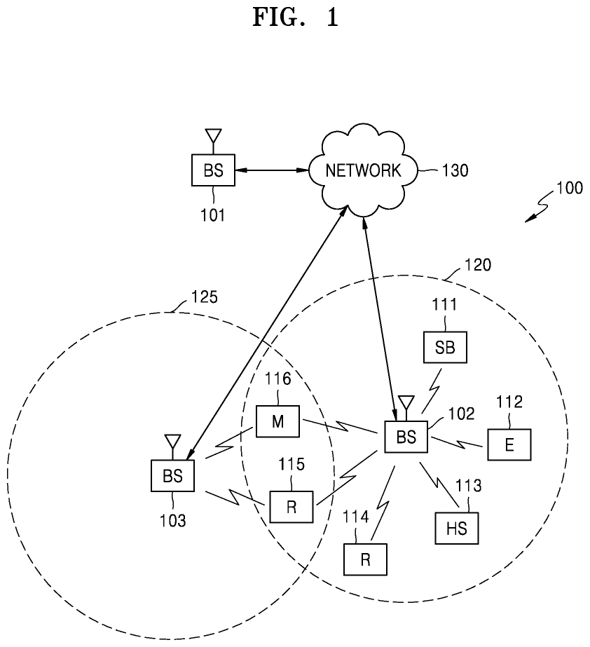

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

To meet the increasing demand for wireless data communication services since the deployment of 4G communication systems, efforts have been made to develop the improved 5G or pre-5G communication systems. Therefore, 5G or pre-5G communication systems are also called “Beyond 4G networks” or “Post-LTE systems”.

In order to achieve a higher data rate, the 5G communication systems are implemented in higher frequency (millimeter, mmWave) bands, e.g., 60 GHz bands. To reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in the 5G communication systems, some system network improvement are underway to be developed based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In the 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “terminal”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of User Equipment (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 may communicate with each other and with the UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs 102 and 103, such as the coverage areas 120 and 125, may have other shapes, including irregular shapes, depending on configurations of the gNBs 102 and 103 and changes in the radio environment associated with natural obstacles and man-made obstacles.

As will be described in more detail below, one or more of the gNB 101, gNB 102 and gNB 103 include a 2D antenna array as described in embodiments of the present disclosure. In some embodiments, one or more of the gNB 101, gNB 102 and gNB 103 support codebook designs and structures for systems with 2D antenna arrays.

Although FIG. 1 illustrates an example of the wireless network 100, various changes can be made to FIG. 1. The wireless network 100 may include any number of gNBs and any number of UEs in any suitable arrangement, for example. Furthermore, the gNB 101 may directly communicate with any number of UEs and provide wireless broadband access to the network 130 for those UEs. Similarly, each gNB 102-103 may directly communicate with the network 130 and provide direct wireless broadband access to the network 130 for the UEs. In addition, the gNB 101, 102 and/or 103 may provide access to other or additional external networks, such as external telephone networks or other types of data networks.

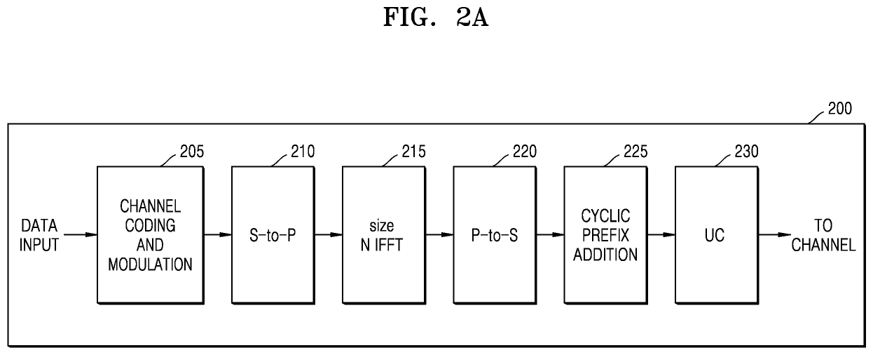

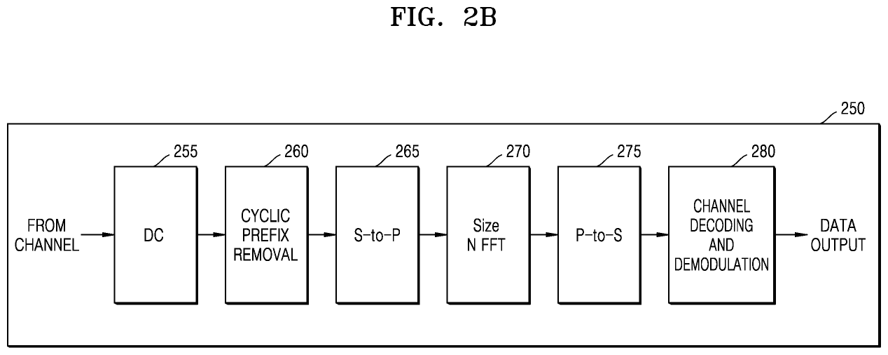

FIG. 2A illustrates an exemplary wireless transmission path according to the present disclosure. FIG. 2B illustrates an exemplary wireless reception path according to the present disclosure. In the following description, the transmission path 200 is described as being implemented in a gNB, such as gNB 102, and the reception path 250 is described as being implemented in a UE, such as UE 116. However, it should be understood that the reception path 250 may be also implemented in the gNB and the transmission path 200 may be also implemented in the UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and performs operations at the UE 116, which are in reverse to those at gNB 102. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of the gNBs 101-103 may implement a transmission path 200 similar to that for transmitting to UEs 111-116 in the downlink, and may implement a reception path 250 similar to that for receiving from the UEs 111-116 in the uplink. Similarly, each of the UEs 111-116 may implement a transmission path 200 for transmitting to the gNBs 101-103 in the uplink, and may implement a reception path 250 for receiving from the gNBs 101-103 in the downlink.

Each of the components in FIGS. 2A and 2B may be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the embodiment.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B may be combined, further subdivided or omitted, and additional components may be added according to specific requirements. Furthermore, FIGS. 2A and 2B are intended to illustrate examples of types of transmission and reception paths that may be used in a wireless network. Any other suitable architecture may be used to support wireless communication in a wireless network.

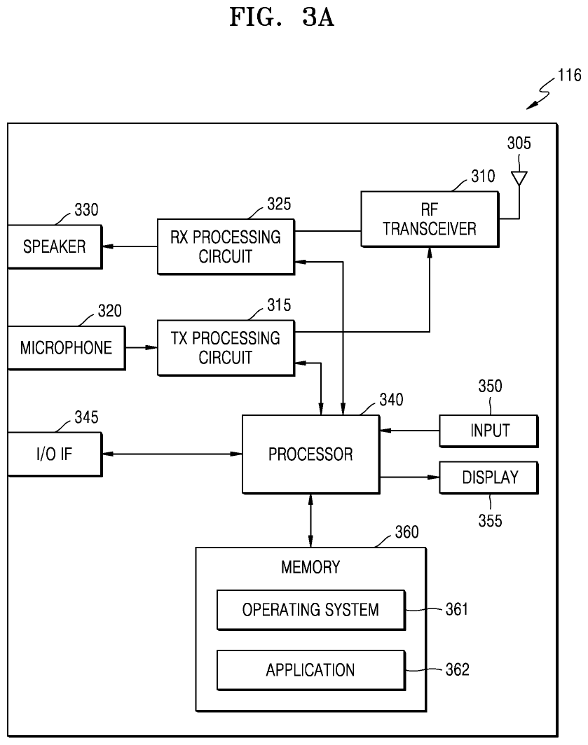

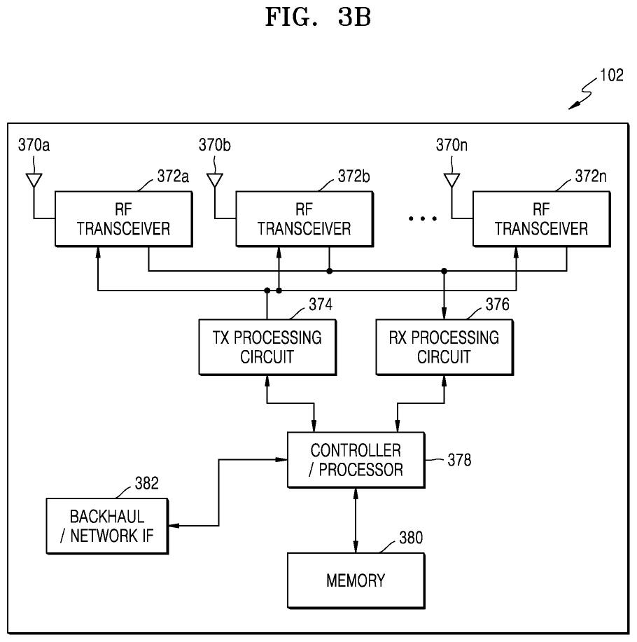

FIG. 3A illustrates an exemplary UE 116 according to the present disclosure. The embodiment of the UE 116 shown in FIG. 3A is for illustration only, and UEs 111-115 of FIG. 1 may have the same or similar configuration. However, the UE may have various configurations, and FIG. 3A does not limit the scope of the present disclosure to any specific embodiment of the UE.

The UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from the processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 may include one or more processors or other processing devices and execute an OS 361 stored in the memory 360 in order to control the overall operation of the UE 116. For example, the processor/controller 340 may control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 may move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides the UE 116 with the ability to connect to other devices such as laptop computers and handheld computers. The I/O interface 345 is a communication path between these accessories and the processor/controller 340.

The processor/controller 340 is also coupled to the input device(s) 350 and the display 355. An operator of the UE 116 may input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 may include a random access memory (RAM), while another part of the memory 360 may include a flash memory or other read-only memory (ROM).

Although FIG. 3A illustrates an example of the UE 116, various changes may be made to FIG. 3A. For example, various components in FIG. 3A may be combined, further subdivided or omitted, and additional components may be added according to specific requirements. As a specific example, the processor/controller 340 may be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an exemplary gNB 102 according to the present disclosure. The embodiment of the gNB 102 shown in FIG. 3B is for illustration only, and other gNBs of FIG. 1 may have the same or similar configuration. However, the gNB 102 has various configurations, and FIG. 3B does not limit the scope of the present disclosure to any specific embodiment of the gNB 102. It should be noted that the gNB 101 and gNB 103 may include the same or similar structures as the gNB 102.

As shown in FIG. 3B, the gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. The gNB 102 also includes a controller/processor 378, a memory 380, and a backhaul or network interface 382.

The plurality of RF transceivers 372a-372n receive an incoming RF signal from the plurality of antennas 370a-370n, such as a signal transmitted by UEs or other gNBs. The plurality of RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. The RX processing circuit 376 transmits the processed baseband signal to controller/processor 378 for further processing.

The TX processing circuit 374 receives analog or digital data (such as voice data, network data, email or interactive video game data) from the controller/processor 378. The TX processing circuit 374 encodes, multiplexes and/or digitizes outgoing baseband data to generate a processed baseband or IF signal. The plurality of RF transceivers 372a-372n receive the outgoing processed baseband or IF signal from the TX processing circuit 374 and up-convert the baseband or IF signal into an RF signal transmitted via antennas 370a-370n.

The controller/processor 378 may include one or more processors or other processing devices that control the overall operation of the gNB 102. For example, the controller/processor 378 may control the reception of forward channel signals and the transmission of backward channel signals through the plurality of RF transceivers 372a-372n, the RX processing circuit 376 and the TX processing circuit 374 according to well-known principles. The controller/processor 378 may also support additional functions, such as higher-level wireless communication functions. For example, the controller/processor 378 may perform a Blind Interference Sensing (BIS) process such as that performed through a BIS algorithm, and decode a received signal from which an interference signal is subtracted. A controller/processor 378 may support any of a variety of other functions in the gNB 102. In some embodiments, the controller/processor 378 includes at least one microprocessor or microcontroller.

The controller/processor 378 is also capable of executing programs and other processes residing in the memory 380, such as a basic OS. The controller/processor 378 may also support channel quality measurement and reporting for systems with 2D antenna arrays as described in embodiments of the present disclosure. In some embodiments, the controller/processor 378 supports communication between entities such as web RTCs. The controller/processor 378 may move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network interface 382 may allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of the gNB 102 (implemented using the plurality of RF transceivers 372a-372n, the TX processing circuit 374 and/or the RX processing circuit 376) support aggregated communication with FDD cells and TDD cells.

Although FIG. 3B illustrates an example of the gNB 102, various changes may be made to FIG. 3B. For example, the gNB 102 may include any number of each component shown in FIG. 3A. As a specific example, the access point can include many backhaul or network interfaces 382, and the controller/processor 378 may support routing functions to route data between different network addresses. As another specific example, although shown as including a single instance of the TX processing circuit 374 and a single instance of the RX processing circuit 376, the gNB 102 may include multiple instances of each (such as one for each RF transceiver).

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it would be obvious to those skilled in the art that modifications to the illustrated embodiments and examples can be made without departing from the scope of the present disclosure.

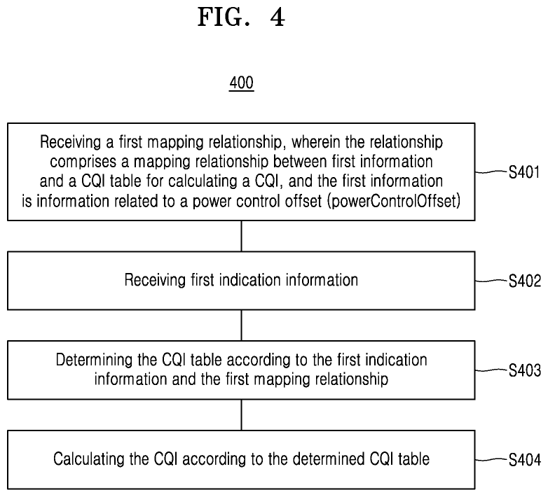

An embodiment of the present disclosure provides a method 400 performed by a user equipment (UE) in a wireless communication system. FIG. 4 illustrates a schematic flow diagram of an embodiment of the method performed by the user equipment in the wireless communication system according to the present disclosure. As shown in FIG. 4, the method 400 performed by the user equipment (UE) in the wireless communication system includes the following steps.

S401, receiving a first mapping relationship, wherein the first mapping relationship comprises a mapping relationship between first information and a CQI table for calculating a CQI, and the first information is information related to a power control offset (powerControlOffset).

S402, receiving first indication information.

S403, determining the CQI table according to the first indication information and the first mapping relationship.

S404, calculating the CQI according to the determined CQI table.

Regarding the aforementioned steps S401 to S404, the first mapping relationship may mean information indicating the first mapping relationship. The first mapping relationship includes a mapping relationship between first information and a CQI table for calculating a CQI, and the first information is information related to a power control offset. The UE may receive the information regarding the first mapping relationship, receive the first indication information, identify the CQI table based on the first indication information and the first mapping relationship and identify the CQI based on the identified CQI table.

In the wireless communication system, the user equipment (UE) may measure a physical downlink shared channel (PDSCH for short) according to a channel state information-reference signal (CSI-RS for short) between the user equipment (UE) and a base station gNB, and may obtain a channel quality indicator (CQI for short) according to the measurement result. Here, the CSI-RS may be a non-zero-power (NZP for short) CSI-RS. The power control offset (powerControlOffset) is information indicating energy or power of the PDSCH in respect to energy or power of the CSI-RS. For example, the power control offset is an assumed ratio of the Energy per resource element (EPRE for short) of the PDSCH to the EPRE of the NZP CSI-RS. The ratio of the EPRE of the NZP CSI-RS to the PDSCH may be a measurement result obtained by taking the powerControlOffset into account.

In an embodiment of the present disclosure, the user equipment (UE) may be any one of the UEs 111-116 in FIG. 1, and the UE may receive the information regarding the first mapping relationship and the first indication information through the signaling of the base station gNB. For example, when being any one of the UEs 111-114, the UE may receive the information regarding the first mapping relationship and the first indication information through the signaling of the gNB 102 in FIG. 1. When being the UE 115 or UE 116, the UE may receive the information regarding the first mapping relationship and the first indication information through the signaling of the gNB 102 or gNB 103 in FIG. 1. The first mapping relationship is used to represent the mapping relationship between the first information related to the power control offset (powerControlOffset) and the CQI table for calculating the channel quality indicator (CQI for short). The first indication information may be used to indicate or correspond to the first information. The CQI table may include a CQI index and at least one channel quality parameter corresponding to the CQI index. For example, the at least one channel quality parameter may include at least one of a modulation mode, a code rate or a spectral efficiency, etc. Generally, the number of CQI tables is more than one, and the at least one channel quality parameter corresponding to a same CQI index in a plurality of CQI tables may be different. The UE may identify one CQI table for identifying the CQI from the plurality of CQI tables according to the first indication information and the mapping relationship between the first information and the CQI table in the first mapping relationship, and identify the CQI according to the determined CQI table.

Alternatively, the plurality of CQI tables may be received by the UE from the gNB and stored into the UE.

Alternatively, the plurality of CQI tables may be configured at the UE.

Alternatively, CQI tables may be configured at the UE and the plurality of CQI tables may be determined through signaling (higher-layer or MAC or L1) from the gNB to the UE.

Alternatively, when calculating the CQI, the UE may identify a CQI index corresponding to the measurement result from the identified CQI table according to the measurement result of the NZP CSI-RS to the PDSCH, and feed back the identified CQI index to the gNB.

According to this embodiment, through the mapping relationship between the information related to the power control offset (powerControlOffset) and the CQI table, the UE may dynamically select a CQI table according to the received indication information to calculate the CQI, without requiring additional signaling (e.g., higher-layer signaling cqi-Table) to identify the CQI table.

In some alternative embodiments of the present disclosure, the first indication information may be received through physical-layer signaling or medium access control-layer signaling. For example, by receiving the physical-layer signaling (also referred to as layer-1 (L1) signaling) of the gNB, the UE obtains the first indication information according to the downlink control information (DCI for short) in the signaling. Alternatively, by receiving the medium-access-control-layer signaling (also referred to as layer-2 (L2) signaling) of the gNB, the UE obtains the first indication information. In some other alternative embodiments of the present disclosure, the information regarding the first mapping relationship may be received through higher-layer signaling. Alternatively, the information regarding the first mapping relationship may be received through medium-access-control-layer signaling or physical-layer signaling or a combination of the aforementioned signalings.

The at least one of tables 1 to 6 shown this disclosure may be used in at least one embodiment of the FIG. 4.

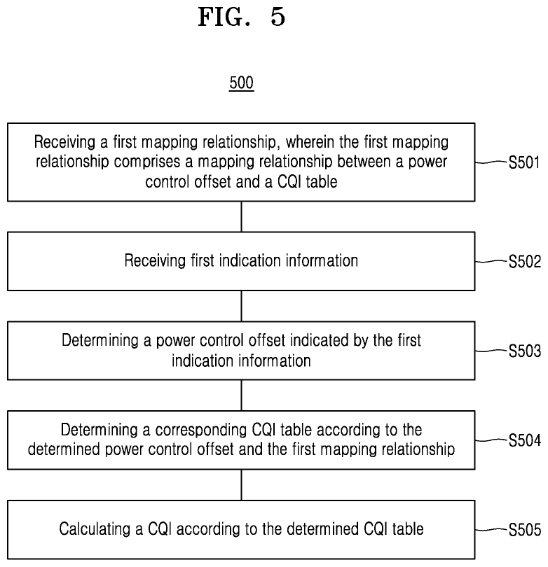

FIG. 5 illustrates a schematic flow diagram of an example of the method performed by the user equipment in the wireless communication system according to some alternative embodiments of the present disclosure. As shown in FIG. 5, the method 500 performed by the user equipment (UE) in the wireless communication system includes the following steps.

S501, receiving a first mapping relationship, wherein the first mapping relationship comprises a mapping relationship between a power control offset and a CQI table.

S502, receiving first indication information.

S503, determining a power control offset indicated by the first indication information.

S504, determining a corresponding CQI table according to the determined power control offset and the first mapping relationship.

S505, calculating a CQI according to the determined CQI table.

Regarding the aforementioned steps S501 to S505, the first mapping relationship may mean information indicating the first mapping relationship. The first mapping relationship includes a mapping relationship between a power control offset and a CQI table. The UE may receive the information regarding the first mapping relationship, receive the first indication information, identify a power control offset indicated by the first indication information, identify the corresponding CQI table based on the identified power control offset and the first mapping relationship and identify the CQI based on the identified CQI table.

In this example, the first information may refer to a power control offset (powerControlOffset). In the first mapping relationship, different powerControlOffsets may correspond to different CQI tables or may correspond to the same CQI table. The first indication information may refer to the powerControlOffset or other information capable of indicating the powerControlOffset. The UE may identify the corresponding CQI tables from the first mapping relationship, according to the powerControlOffset indicated by the first indication information.

According to this example, the UE may directly receive information indicating the power control offset (powerControlOffset), and dynamically select, based on the mapping relationship between the powerControlOffset and the CQI table, a CQI table adapted to the received powerControlOffset to identify the CQI.

The at least one of tables 1 to 6 shown this disclosure may be used in at least one embodiment of the FIG. 5.

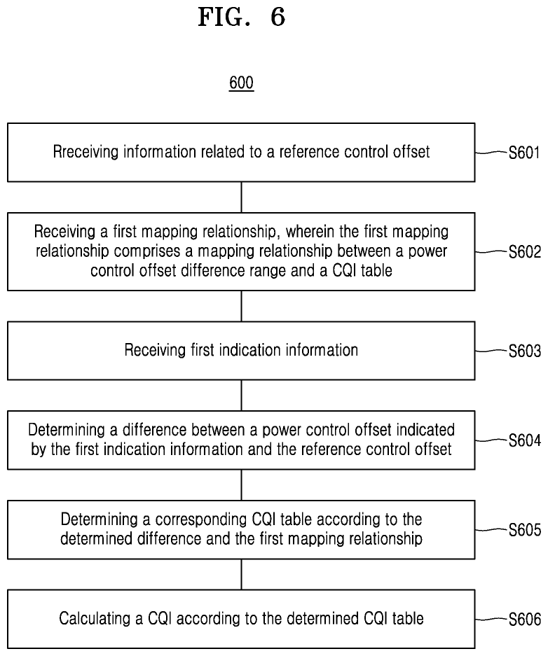

FIG. 6 illustrates a schematic flow diagram of an other example of the method performed by the user equipment in the wireless communication system according to some alternative embodiments of the present disclosure. As shown in FIG. 6, the method 600 performed by the user equipment (UE) in the wireless communication system includes the following steps.

S601, receiving information related to a reference power control offset.

S602, receiving a first mapping relationship, wherein the first mapping relationship comprises a mapping relationship between a power control offset difference range and a CQI table.

S603, receiving first indication information.

S604, determining a difference between a power control offset indicated by the first indication information and the reference power control offset.

S605, determining a corresponding CQI table according to the determined difference and the first mapping relationship.

S606, calculating a CQI according to the determined CQI table.

Regarding the aforementioned steps S601 to S606, the first mapping relationship may mean information indicating the first mapping relationship. The first mapping relationship includes a mapping relationship between a power control offset difference range and a CQI table. The UE may receive the information related to the reference power control offset, receive information regarding the first mapping relationship, receive the first indication information, determine the difference between the power control offset indicated by the first indication information and the reference power control offset, identify the corresponding CQI table based on the determined difference and the first mapping relationship and identify the CQI based on the identified CQI table.

In this embodiment, the first information may refer to a power control offset (powerControlOffset) difference range. In the first mapping relationship, different powerControlOffset difference ranges may correspond to different CQI tables. The first indication information may refer to the powerControlOffset or other information capable of indicating the powerControlOffset. The UE may identify the corresponding CQI table from the first mapping relationship according to the difference between the powerControlOffset indicated by the first indication information and the reference powerControlOffset.

In the present disclosure, “reference power control offset” is not uniquely and invariably named, and it may be used interchangeably with the “datum power control offset,” “initial power control offset,” etc.

Exemplarily, the UE may obtain the reference power control offset by receiving higher-layer signaling. Alternatively, the UE may obtain, by receiving higher-layer signaling, a plurality of power control offsets and indication information to determine the reference power control offset, wherein the indication information indicates that one of the plurality of power control offsets is the reference power control offset. The indication information may be received via higher-layer signaling or MAC signaling or L1 signaling. Alternatively, the UE may obtain a plurality of power control offsets by receiving higher-layer signaling, and obtain the reference power control offset according to a preset rule (e.g., a rule agreed between a base station and the UE, or a predefined rule in the standards), for example, a power control offset having a minimal value in the plurality of power control offsets is the reference power control offset, or a power control offset having a maximal value in the plurality of power control offsets is the reference power control offset.

In this example, the mapping relationship between the power control offset (powerControlOffset) difference range and the CQI table is established, the powerControlOffset is received and the difference between the received powerControlOffset and the reference powerControlOffset is determined, and thus, it is possible to dynamically select a CQI table adapted to the determined powerControlOffset difference to identify the CQI, which is simple and highly applicable.

The at least one of tables 1 to 6 shown this disclosure may be used in at least one embodiment of the FIG. 6.

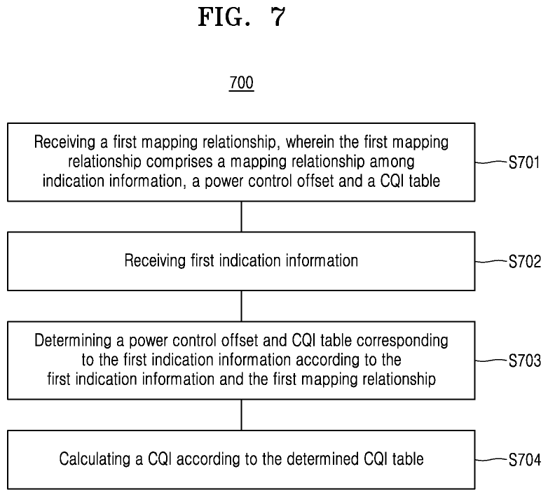

FIG. 7 illustrates a schematic flow diagram of an other example of the method performed by the user equipment in the wireless communication system according to some other alternative embodiments of the present disclosure. As shown in FIG. 7, the method 700 performed by the user equipment (UE) in the wireless communication system includes the following steps.

S701, receiving a first mapping relationship, wherein the first mapping relationship comprises a mapping relationship among indication information, a power control offset and a CQI table.

S702, receiving first indication information.

S703, determining a power control offset and CQI table corresponding to the first indication information according to the first indication information and the first mapping relationship.

S704, calculating a CQI according to the determined CQI table.

Regarding the aforementioned steps S701 to S704, the first mapping relationship may mean information indicating the first mapping relationship. The first mapping relationship includes a mapping relationship among indication information, a power control offset and a CQI table. The UE may receive the information regarding the first mapping relationship, receive the first indication information, identify a power control offset and the CQI table corresponding to the first indication information based on the first indication information and the first mapping relationship and identify the CQI based on the identified CQI table.

In this example, the first information may refer to indication information and a power control offset (powerControlOffset) corresponding to the indication information. In the first mapping relationship, different indication information and powerControlOffsets may correspond to different CQI tables or may correspond to the same CQI table. Here, the indication information may refer to a code for the powerControlOffset. The UE may determine the corresponding powerControlOffset and CQI table from the first mapping relationship according to the first indication information.

In this example, the mapping relationship among the indication information, the powerControlOffset and the CQI table is established, and thus, it is possible to dynamically select a powerControlOffset corresponding to the received indication information and a CQI table adapted to the powerControlOffset according to the received indication information, to identify the CQI, thereby satisfying the requirement of the UE on information security.

The at least one of tables 1 to 6 shown this disclosure may be used in at least one embodiment of the FIG. 7.

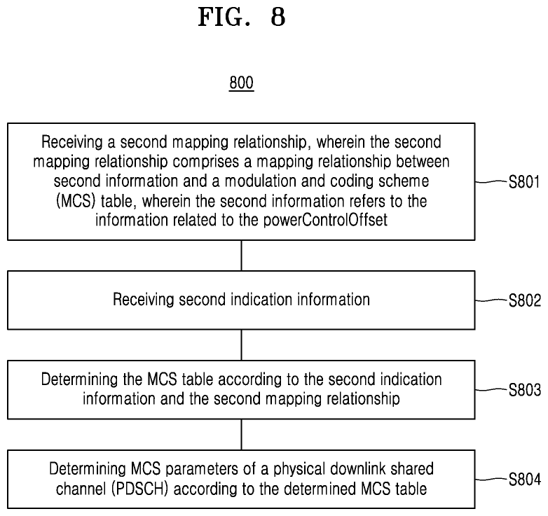

The present disclosure further provides a method 800 performed by a user equipment (UE) in a wireless communication system. FIG. 8 illustrates a schematic flow diagram of an other embodiment of the method performed by the user equipment in the wireless communication system according to the present disclosure. As shown in FIG. 8, the method 800 performed by the user equipment in the wireless communication system includes the following steps.

S801, receiving a second mapping relationship, wherein the second mapping relationship comprises a mapping relationship between second information and a modulation and coding scheme (MCS) table, wherein the second information refers to the information related to the powerControlOffset.

S802, receiving second indication information.

S803, determining the MCS table according to the second indication information and the second mapping relationship.

S804, determining MCS parameters of a physical downlink shared channel (PDSCH) according to the determined MCS table.

Regarding the aforementioned steps S801 to S804, the second mapping relationship may mean information indicating the second mapping relationship. The second mapping relationship includes a mapping relationship between the second information and the MCS table. The UE may receive the information regarding the second mapping relationship, receive the second indication information, identify the MCS table based on the second indication information and the second mapping relationship, and identify at least one MCS parameter of the PDSCH based on the identified MCS table.

In an embodiment of the present disclosure, the user equipment (UE) may be any one of the UEs 111-116 in FIG. 1, and the UE may receive the second mapping relationship and the second indication information through the signaling of the base station gNB. For example, when being any one of the UEs 111-114, the UE may receive the second mapping relationship and the second indication information through the signaling of the gNB 102 in FIG. 1. When being the UE 115 or UE 116, the UE may receive the second mapping relationship and the second indication information through the signaling of the gNB 102 or gNB 103 in FIG. 1. The second mapping relationship is used to represent the mapping relationship between the second information related to the powerControlOffset and the MCS table. The second indication information is used to indicate the second information. The MCS table includes an MCS index and at least one coding scheme parameter corresponding to the MCS index. For example, the at least one coding scheme parameter may include at least one of a modulation mode, a code rate or a spectral efficiency, etc. Generally, the number of MCS tables is more than one, and the coding scheme parameters corresponding to the identical MCS indices in a plurality of MCS tables may be different. The UE may identify one MCS table from the plurality of MCS tables based on the second indication information and the mapping relationship between the second information and the MCS table in the second mapping relationship, and identify the at least one MCS parameter of the PDSCH based on the identified MCS table.

Alternatively, the plurality of MCS tables may be received by the UE from the gNB and then be stored into the UE.

Alternatively, the plurality of MCS tables may be configured at the UE.

Alternatively, MCS tables may be configured at the UE and the plurality of MCS tables may be determined through signaling (higher-layer or MAC or L1) from the gNB to the UE.

According to this embodiment of the present disclosure, through the mapping relationship between the information related to the powerControlOffset and the MCS table, the MCS table may be dynamically selected according to the received indication information to identify the MCS parameters, without requiring additional signaling (e.g., higher-layer signaling mcs-Table) to identify the MCS table.

In some alternative embodiments of the present disclosure, the second indication information is received through physical-layer signaling or medium-access-control-layer signaling. For example, by receiving the physical-layer signaling (also referred to as layer-1 (L1) signaling) of the gNB, the UE obtains the second indication information according to the downlink control information (DCI) in the signaling. Alternatively, by receiving the medium-access-control-layer signaling (also referred to as layer-2 (L2) signaling) of the gNB, the UE obtains the second indication information. In some other alternative embodiments of the present disclosure, the indication information may be received through higher-layer signaling.

The at least one of tables 7 to 12 shown this disclosure may be used in at least one embodiment of the FIG. 8.

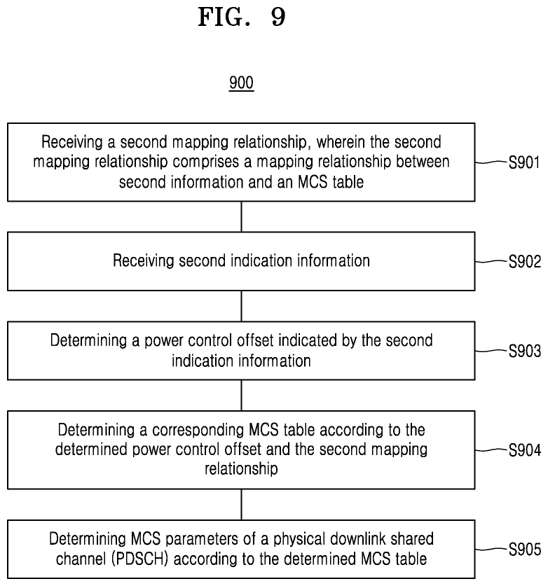

FIG. 9 illustrates a schematic flow diagram of an other example of the method performed by the user equipment in the wireless communication system according to some alternative embodiments of the present disclosure. As shown in FIG. 9, the method 900 performed by the user equipment (UE) in the wireless communication system includes the following steps.

S901, receiving a second mapping relationship, wherein the second mapping relationship comprises a mapping relationship between second information and an MCS table. S902, receiving second indication information.

S903, determining a power control offset indicated by the second indication information.

S904, determining a corresponding MCS table according to the determined power control offset and the second mapping relationship.

S905, determining MCS parameters of a physical downlink shared channel (PDSCH) according to the determined MCS table.

Regarding the aforementioned steps S901 to S905, the second mapping relationship may mean information indicating the second mapping relationship. The second mapping relationship includes a mapping relationship between the second information and the MCS table. The UE may receive the information regarding the second mapping relationship, receive the second indication information, identify a power control offset indicated by the second indication information, identify the corresponding MCS table based on the identified power control offset and the second mapping relationship, and identify at least one MCS parameter of the PDSCH based on the identified MCS table.

In this embodiment, the second information may refer to a power control offset (powerControlOffset). In the second mapping relationship, different powerControlOffsets may correspond to different MCS tables or may correspond to the same MCS table. The second indication information may refer to the powerControlOffset or other information capable of indicating the powerControlOffset. The UE can identify the corresponding MCS table from the second mapping relationship based on the powerControlOffset indicated by the second indication information.

According to this example, it is possible to directly receive the powerControlOffset, and dynamically select the MCS table adapted to the received powerControlOffset through the mapping relationship between the powerControlOffset and the MCS table, to identify the at least one MCS parameter.

The at least one of tables 7 to 12 shown this disclosure may be used in at least one embodiment of the FIG. 9.

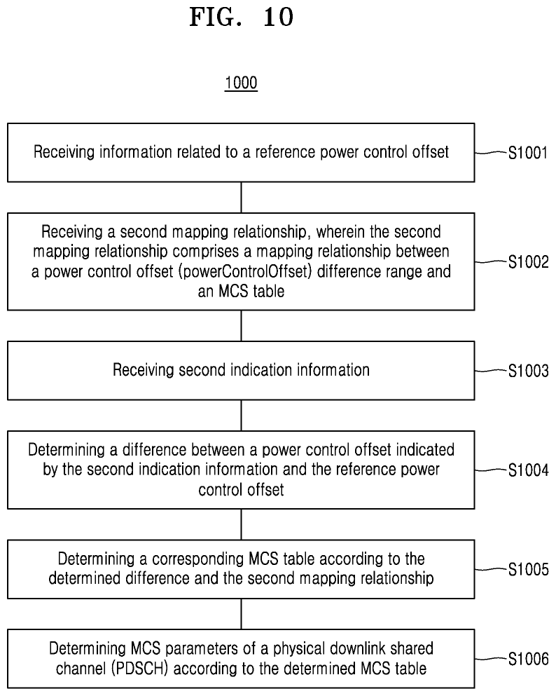

FIG. 10 illustrates a schematic flow diagram of an other example of the method performed by the user equipment in the wireless communication system according to some other alternative embodiments of the present disclosure. As shown in FIG. 10, the method 1000 performed by the user equipment (UE) in the wireless communication system includes the following steps.

S1001, receiving information related to a reference power control offset.

S1002, receiving a second mapping relationship, wherein the second mapping relationship comprises a mapping relationship between a power control offset (powerControlOffset) difference range and an MCS table.

S1003, receiving second indication information.

S1004, determining a difference between a power control offset indicated by the second indication information and the reference power control offset.

S1005, determining a corresponding MCS table according to the determined difference and the second mapping relationship.

S1006, determining MCS parameters of a physical downlink shared channel (PDSCH) according to the determined MCS table.

Regarding the aforementioned steps S1001 to S1006, the second mapping relationship may mean information indicating the second mapping relationship. The second mapping relationship includes a mapping relationship between the power control offset difference range and the MCS table. The UE may receive information related to the reference power control offset, receive the information regarding the second mapping relationship, receive the second indication information, identify the difference between the power control offset indicated by the second indication information and the reference power control offset, identify the corresponding MCS table based on the identified difference and the second mapping relationship, and identify at least one MCS parameter of the PDSCH based on the identified MCS table.

In this example, the second information may refer to the powerControlOffset difference range. In the second mapping relationship, different powerControlOffset difference ranges may correspond to different MCS tables. The second indication information may refer to the powerControlOffset or other information capable of indicating the powerControlOffset. The UE may identify the corresponding MCS table from the second mapping relationship according to the difference between the powerControlOffset indicated by the second indication information and the reference powerControlOffset.

Here, the UE may obtain the reference power control offset by receiving higher-layer signaling. Alternatively, the UE may obtain a plurality of power control offsets by receiving higher-layer signaling, wherein one of the plurality of power control offsets is the reference power control offset. The one of the plurality of power control offsets may be explicitly or implicitly indicated to the UE via the higher-layer signaling or MAC signaling or L1 signaling. Alternatively, the UE may obtain a plurality of power control offsets by receiving higher-layer signaling, and obtain the reference power control offset according to a preset rule, for example, a power control offset having a minimal value in the plurality of power control offsets is the reference power control offset, or a power control offset having a maximal value in the plurality of power control offsets is the reference power control offset.

In this example, the mapping relationship between the powerControlOffset difference range and the MCS table is established, the powerControlOffset is received and the difference between the received powerControlOffset and the reference powerControlOffset is determined, and thus, it is possible to dynamically select the MCS table adapted to the determined powerControlOffset difference to determine the MCS parameters, which is simple and highly applicable.

The at least one of tables 7 to 12 shown this disclosure may be used in at least one embodiment of the FIG. 10.

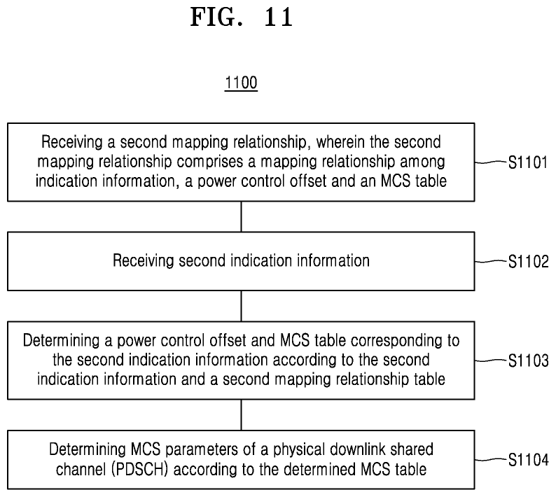

FIG. 11 illustrates a schematic flow diagram of an other example of the method performed by the user equipment in the wireless communication system according to some other alternative embodiments of the present disclosure. As shown in FIG. 11, the method 1100 performed by the user equipment (UE) in the wireless communication system includes the following steps.

S1101, receiving a second mapping relationship, wherein the second mapping relationship comprises a mapping relationship among indication information, a power control offset (powerControlOffset) and an MCS table.

S1102, receiving second indication information.

S1103, determining a power control offset and MCS table corresponding to the second indication information according to the second indication information and a second mapping relationship table.

S1104, determining MCS parameters of a physical downlink shared channel (PDSCH) according to the determined MCS table.

Regarding the aforementioned steps S1101 to S1104, the second mapping relationship may mean information indicating the second mapping relationship. The second mapping relationship includes a mapping relationship among the indication information, the power control offset and the MCS table. The UE may receive the information regarding the second mapping relationship, receive the second indication information, identify the power control offset and the MCS table corresponding to the second indication information based on the second indication information and the second mapping relationship table and identify at least one MCS parameter of the PDSCH based on the identified MCS table.

In this example, the second information may refer to the indication information and the powerControlOffset corresponding to the indication information. In the second mapping relationship, different indication information and powerControlOffsets may correspond to different MCS tables or may correspond to the same MCS table. The indication information may refer to a code for the powerControlOffset. The UE may identify the corresponding powerControlOffset and MCS table from the second mapping relationship according to the second indication information.

In this example, the mapping relationship among the indication information, the powerControlOffset and the MCS table is established, and thus, it is possible to dynamically select the powerControlOffset corresponding to the received indication information and the MCS table adapted to the powerControlOffset according to the received indication information to identify the at least one MCS parameter, thereby satisfying the requirement of the UE on information security.

The at least one of tables 7 to 12 shown this disclosure may be used in at least one embodiment of the FIG. 11.

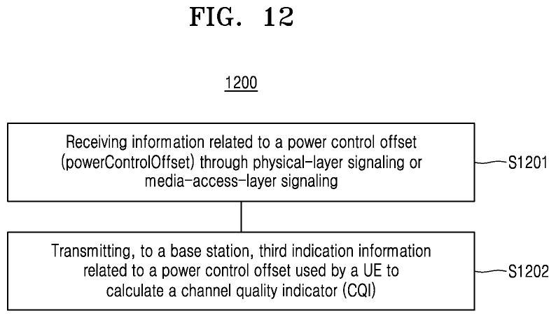

An embodiment of the present disclosure further provides a method performed by a user equipment (UE) in a wireless communication system. FIG. 12 illustrates a schematic flow diagram of an other embodiment of the method 1200 performed by the user equipment in the wireless communication system according to the present disclosure. As shown in FIG. 12, the method 1200 performed by the user equipment (UE) in the wireless communication system includes the following steps.

S1201, receiving information related to a power control offset (powerControlOffset) through physical-layer signaling or medium-access-control-layer signaling.

S1202, transmitting, to a base station, third indication information related to a power control offset used by a UE to calculate a channel quality indicator (CQI).

When receiving the information related to the powerControlOffset from the base station gNB through the physical-layer signaling or the medium-access-control-layer signaling, the UE transmits, to the base station, the powerControlOffset used by the UE to identify the CQI, to make the gNB know that the UE correctly receives the powerControlOffset, which provides assurance that the gNB and the UE have the same understandings on the powerControlOffset for calculating the CQI, thereby assuring the correctness of communication.

In some alternative embodiments of the present disclosure, the third indication information may be transmitted through the signaling by which the UE report CQI-related information to the base station. In some alternative examples, the third indication information may be used to indicate whether the power control offset used by the UE to identify the CQI is changed, and the third indication information may be transmitted through the signaling, which is used to report the CQI-related information for the first time after the power control offset used by the UE to identify the CQI is changed. In some other alternative examples, the third indication information may be used to indicate whether the power control offset used by the UE to identify the CQI is changed, and the third indication information may be transmitted through the signaling, which is used to report the CQI-related information each time. In some other alternative examples, the third indication information may be used to indicate the power control offset used by the UE to identify the CQI, and the third indication information may be transmitted through the signaling for reporting the CQI-related information each time.

Since the third indication information is transmitted through the signaling for reporting, by the UE, the CQI-related information to the base station, it can be assured through a simple approach that the gNB and the UE have the same understandings on the power control offset (powerControlOffset) for calculating the CQI.

In some other alternative embodiments of the present disclosure, the information related to the power control offset may be received through downlink control information (DCI), and the third indication information may be transmitted to the base station through a first hybrid automatic repeat request acknowledgement (HARQ-ACK), wherein the first HARQ-ACK is the acknowledgement, by the UE, for the DCI for transmitting the power control offset. The third indication information may be implicitly or explicitly transmitted to the base station through the first HARQ-ACK. In some alternative examples, the UE may obtain, through higher-layer signaling, a first physical uplink control channel (PUCCH) resource for transmitting the first HARQ-ACK, and the first HARQ-ACK may be transmitted on the first PUCCH resource. In some other alternative examples, the UE may obtain, through the higher-layer signaling, a second PUCCH resource for transmitting a second HARQ-ACK of a physical downlink shared channel (PDSCH), and the first HARQ-ACK may be transmitted on the second PUCCH resource. In some other alternative examples, the UE may obtain, through the higher-layer signaling, the second PUCCH resource for transmitting the second HARQ-ACK of the PDSCH. In these examples, if the UE obtains, through the higher-layer signaling, the first PUCCH resource for transmitting the first HARQ-ACK, the first HARQ-ACK is transmitted on the first PUCCH resource. If the UE does not obtain the first PUCCH resource for transmitting the first HARQ-ACK, the first HARQ-ACK is transmitted on the second PUCCH resource. In some alternative examples, the UE may obtain, through higher-layer signaling, a first physical downlink control channel (PDCCH) resource, receive, on the first PDCCH resource, DCI indicating the first PUCCH resource for transmitting the first HARQ-ACK, and the first HARQ-ACK may be transmitted on the first PUCCH resource.

In the above embodiments of the present disclosure, the HARQ-ACK for transmitting the power control offset indication information and the HARQ-ACK of the PDSCH may be multiplexed on one PUCCH. In some alternative examples, in the situation where the first HARQ-ACK is transmitted on the second PUCCH resource, the first HARQ-ACK is arranged before or behind the sequence, which is formed by arranging the HARQ-ACK of a PDSCH scheduled by the DCI and the HARQ-ACK of a semi-persistent (SPS) PDSCH, to form a total HARQ-ACK sequence, and the total HARQ-ACK sequence is transmitted on the second PUCCH resource. In some other alternative examples, in the situation where the first HARQ-ACK is transmitted on the second PUCCH resource, the HARQ-ACK of the semi-persistent (SPS) PDSCH is arranged behind the sequence, which is formed by arranging the HARQ-ACK of the PDSCH scheduled by the DCI and the first HARQ-ACK, to form a total HARQ-ACK sequence, and the total HARQ-ACK sequence is transmitted on the second PUCCH resource. In some alternative examples, the power control offset indication information is transmitted implicitly by UL configuration of the HARQ-ACK.

The method of transmitting the power control offset indication information with the HARQ-ACK may be applied when the UE transmits the power control offset indication information with CSI.

In the description of the present disclosure, “first information,” “second information,” “first indication information,” “second indication information,” “third indication information,” etc. are not uniquely and invariably named. For example, the “first indication information” may be the same as or different from the “second indication information.”

The method performed by the user equipment (UE) in the wireless communication system, which is applicable to the above embodiments of the present disclosure, will be further described below through specific examples.

### Example 1

The method in this example is used to identify a channel quality indicator (CQI). This method is implemented on a UE side, and includes the following steps.

Step 1, receiving, by a UE, first indication information. In the present disclosure, “first indication information” is not uniquely and invariably named. In particular, it may be used interchangeably with the “powerControlOffset indication information” or a similar name.

Step 2, identifying, by the UE, a CQI table for identifying a CQI according to the first indication information.

Step 3, identifying, by the UE, the CQI according to the identified CQI table for calculating the CQI.

Step 4, feeding back, by the UE, the identified CQI to a base station.

Here, the UE obtains a CQI for a physical downlink shared channel (PDSCH) according to the measurement for a channel state information-reference signal (CSI-RS), and the CSI-RS may be an NZP CSI-RS. When identifying the CQI, it is assumed that the ratio of the Energy per resource element (EPRE) of the PDSCH to the EPRE of the NZP CSI-RS is the power control offset (powerControlOffset). Here, the UE obtains the powerControlOffset by receiving signaling, and then identifies the CQI. In addition, the CQI fed back by the UE is a CQI index in the CQI table. The form of the CQI table is as shown in Tables 1, 2 and 3. Here, for identical CQI indices in Tables 1, 2, and 3, the modulation modes, code rates and spectral efficiencies corresponding to the CQI indices may be different. Therefore, before feeding back the CQI, the UE further receives one piece of higher-layer signaling (e.g., cqi-Table) to determine one of Tables 1, 2 and 3 as the table for identifying the CQI.

TABLE 1
4-bit CQI Table

| CQI index | Modulation | Code rate x 1024 | Spectral efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

TABLE 2
4-bit CQI Table

| CQI index | Modulation | Code rate x 1024 | Spectral efficiency |
|---|---|---|---|
| 0 | out of range | | |
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |

TABLE 3
4-bit CQI Table

| CQI index | Modulation | Code rate x 1024 | Spectral efficiency |
|---|---|---|---|
| 0 | out of range | | |
| 1 | QPSK | 78 | 0.1523 |
| 2 | QPSK | 193 | 0.377 |
| 3 | QPSK | 449 | 0.877 |
| 4 | 16QAM | 378 | 1.4766 |
| 5 | 16QAM | 616 | 2.4063 |
| 6 | 64QAM | 567 | 3.3223 |
| 7 | 64QAM | 666 | 3.9023 |
| 8 | 64QAM | 772 | 4.5234 |
| 9 | 64QAM | 873 | 5.1152 |
| 10 | 256QAM | 711 | 5.5547 |
| 11 | 256QAM | 797 | 6.2266 |
| 12 | 256QAM | 885 | 6.9141 |
| 13 | 256QAM | 948 | 7.4063 |
| 14 | 1024QAM | 853 | 8.3301 |
| 15 | 1024QAM | 948 | 9.2578 |

In the above method of identifying the CQI, the UE obtains the powerControlOffset by receiving the signaling, and the UE determines one of Tables 1, 2 and 3 as the table for identifying the CQI, by receiving one piece of higher-layer signaling (e.g., cqi-Table).

Alternatively, the UE receives the powerControlOffset through physical-layer signaling (also referred to as layer-1 (L1) signaling), for example, the UE obtains the powerControlOffset by receiving DCI. Alternatively, the UE receives the powerControlOffset through medium-access-control-layer signaling (also referred to as layer-2 (L2) signaling), for example, the UE obtains the powerControlOffset by receiving a MAC (medium access control) CE (Control Element). How to obtain the table for identifying the CQI will be further described below.

### Method 1:

First, the UE obtains a mapping relationship between a powerControlOffset and a table for identifying a CQI, by receiving signaling (e.g., higher-layer signaling). Then, the UE obtains a powerControlOffset by receiving physical-layer signaling or medium-access-control-layer signaling. Next, the UE obtains a table for identifying a CQI, according to the powerControlOffset and the mapping relationship between the powerControlOffset and the table for identifying the CQI. Finally, the UE identifies the CQI. For example, the UE may receive the information indicating the powerControlOffset through the physical-layer signaling or medium-access-control-layer signaling, for example, “00”, “01” and “10” which respectively indicate powerControlOffset-1, powerControlOffset-2 and powerControlOffset-3.

For example, by receiving the higher-layer signaling, the UE obtains the mapping relationship between the powerControlOffset and the table for identifying the CQI, the mapping relationship being as shown in Table 4. By receiving the physical-layer signaling or medium-access-control-layer signaling, the UE obtains the powerControlOffset that is powerControlOffset-1. By using powerControlOffset-1, the UE identifies from Table 4 that the table used for identifying the CQI and corresponding to powerControlOffset-1 is Table 1. The UE identifies the CQI according to powerControlOffset-1 and Table 1.

TABLE 4
Mapping relationship between powerControlOffset
and CQI table for identifying CQI

| powerControlOffset | Table for identifying CQI |
|---|---|
| powerControlOffset-1 | Table 1 |
| powerControlOffset-2 | Table 1 |
| powerControlOffset-3 | Table 2 |

### Method 2:

First, the UE obtains a mapping relationship among the powerControlOffset indication information, the powerControlOffset and the table for identifying the CQI, by receiving signaling (e.g., higher-layer signaling). Then, the UE obtains the powerControlOffset and the table for identifying the CQI, by receiving physical-layer signaling or medium-access-control-layer signaling. Next, the UE obtains the table for identifying the CQI, according to the powerControlOffset indication information and the mapping relationship among the powerControlOffset indication information, the powerControlOffset and the table for identifying the CQI. Finally, the UE identifies the CQI.

For example, by receiving the higher-layer signaling, the UE obtains the mapping relationship among the powerControlOffset indication information, the powerControlOffset and the table for identifying the CQI, the mapping relationship being as shown in Table 5. By receiving the physical-layer signaling, the UE identifies that the powerControlOffset indication information is “01”. By using the powerControlOffset indication information “01”, the UE identifies from Table 5 that the powerControlOffset is powerControlOffset-2 and the table for identifying the CQI is Table 1. The UE identifies the CQI according to powerControlOffset-2 and Table 1.

TABLE 5
Mapping relationship among indication information index,
powerControlOffset and CQI table for identifying CQI

| Indication | | Table for |
|---|---|---|
| information | powerControlOffset | identifying CQI |
| 00 | powerControlOffset-1 | Table 1 |
| 01 | powerControlOffset-2 | Table 1 |
| 10 | powerControlOffset-3 | Table 2 |

By using this method, it is possible to dynamically select an appropriate table for identifying the CQI, without requiring additional signaling. Accordingly, the CQI is identified and fed back more precisely.

### Method 3:

First, the UE obtains an initial powerControlOffset and an initial table for identifying the CQI, by receiving signaling (e.g., higher-layer signaling). Then, the UE obtains, by receiving the higher-layer signaling, a mapping relationship between a difference (between the initial powerControlOffset and a new powerControlOffset) and the table for identifying the CQI, or the UE presets and obtains the mapping relationship. Then, the UE obtains the new powerControlOffset by receiving physical-layer signaling or medium-access-control-layer signaling. Next, the UE calculates the difference between the initial powerControlOffset and the new powerControlOffset. Then, the UE obtains the table for identifying the CQI, according to the mapping relationship between the difference (between the initial powerControlOffset and the new powerControlOffset) and the table for identifying the CQI. Finally, the UE identifies and feeds back a CQI.

For example, by receiving the higher-layer signaling, the UE obtains the initial powerControlOffset-initial and the initial table (Tables 1-3) for identifying the CQI. By receiving the higher-layer signaling, the UE obtains the mapping relationship between the difference (between powerControlOffset-initial and powerControlOffset-new) and the table for identifying the CQI, the mapping relationship being as shown in Table 6. The UE obtains the new powerControlOffset-new by receiving the physical-layer signaling or medium-access-control-layer signaling. The UE calculates and obtains the difference c between powerControlOffset-initial and powerControlOffset-new, and a<c<=b. By using a difference m between powerControlOffset-initial and powerControlOffset-new, the UE determines from Table 6 that the table for identifying the CQI is Table 2. The UE identifies the CQI according to powerControlOffset-new and Table 1. The difference range shown in Table 6 is only exemplary. For example, the range of the difference c corresponding to Table 2 may alternatively be a<c<b, and the range of the difference c corresponding to Table 1 may alternatively be b<=c.

TABLE 6
Mapping between difference between powerControlOffset-initial and
powerControlOffset-new and table for identifying CQI

| Difference c between powerControlOffset- | Table for |
|---|---|
| initial and powerControlOffset-new | identifying CQI |
| c <= a | Table 1 |
| a < c <= b | Table 1 |
| b < c | Table 2 |

By using this method, it is possible to dynamically select an appropriate table for identifying the CQI, without requiring additional signaling. Accordingly, the CQI is identified and fed back more precisely.

### Example 2

The method in this example is used to determine the modulation order and the target code rate of the PDSCH. This method is implemented on a UE side, and includes the following steps.

Step 1, receiving, by a UE, second indication information.

Step 2, obtaining, by the UE, an MCS table for identifying a modulation order and a target code rate of a PDSCH, according to the second indication information.

Step 3, receiving, by the UE, information of the PDSCH according to the identified MCS table for identifying the modulation order and the target code rate of the PDSCH.

Here, the UE receives higher-layer signaling to obtain the MCS table of the PDSCH. Then, the UE receives an MCS field in the PDCCH to obtain an MCS index, and receives the information of the PDCCH according to the MCS index and the MCS table. The form of the MCS table is as shown in Tables 7, 8 and 9. Here, for identical MCS indices in Tables 7, 8 and 9, the modulation modes, the code rates and the spectral efficiencies corresponding to the MCS indices may be different. Therefore, before receiving the PDCCH and the PDSCH, the UE further receives one piece of higher-layer signaling (e.g., mcs-Table) to determine one of Tables 7, 8 and 9 as the table for receiving the PDSCH.

TABLE 7
MCS Table of PDSCH

| MCS | Modulation | Target code | |
|---|---|---|---|
| Index | Order | Rate (R) x | Spectral |
| (IMCS) | (Qm) | [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

TABLE 8
MCS Table of PDSCH

| MCS Index | Modulation Order | Target code Rate | Spectral |
|---|---|---|---|
| (IMCS) | (Qm) | (R) x [1024] | efficiency |
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.6953 |
| 7 | 4 | 490 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 567 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 5.1152 |
| 20 | 8 | 682.5 | 5.3320 |
| 21 | 8 | 711 | 5.5547 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |

| | | |
|---|---|---|
| 28 | 2 | reserved |
| 29 | 4 | reserved |
| 20 | 6 | reserved |
| 31 | 8 | reserved |

TABLE 9
MCS Table of PDSCH

| MCS | Modulation | Target code | |
|---|---|---|---|
| Index | Order | Rate (R) x | Spectral |
| (IMCS) | (Qm) | [1024] | efficiency |
| 0 | 2 | 120 | 0.2344 |
| 1 | 2 | 193 | 0.3770 |
| 2 | 2 | 449 | 0.8770 |
| 3 | 4 | 378 | 1.4766 |
| 4 | 4 | 490 | 1.9141 |
| 5 | 4 | 616 | 2.4063 |
| 6 | 6 | 466 | 2.7305 |
| 7 | 6 | 517 | 3.0293 |
| 8 | 6 | 567 | 3.3223 |
| 9 | 6 | 616 | 3.6094 |
| 10 | 6 | 666 | 3.9023 |
| 11 | 6 | 719 | 4.2129 |
| 12 | 6 | 772 | 4.5234 |
| 13 | 6 | 822 | 4.8164 |
| 14 | 6 | 873 | 5.1152 |
| 15 | 8 | 682.5 | 5.3320 |
| 16 | 8 | 711 | 5.5547 |
| 17 | 8 | 754 | 5.8906 |
| 18 | 8 | 797 | 6.2266 |
| 19 | 8 | 841 | 6.5703 |
| 20 | 8 | 885 | 6.9141 |
| 21 | 8 | 916.5 | 7.1602 |
| 22 | 8 | 948 | 7.4063 |
| 23 | 10 | 805.5 | 7.8662 |
| 24 | 10 | 853 | 8.3301 |
| 25 | 10 | 900.5 | 8.7939 |
| 26 | 10 | 948 | 9.2578 |

| | | |
|---|---|---|
| 27 | 2 | reserved |
| 28 | 4 | reserved |
| 29 | 6 | reserved |
| 30 | 8 | reserved |
| 31 | 10 | reserved |

In the above method of receiving the PDSCH, the UE receives one piece of higher-layer signaling (e.g., mcs-Table) to identify one of Tables 7, 8 and 9 as the MCS index table for receiving the PDSCH.

Here, the UE obtains a powerControlOffset by receiving physical-layer signaling (also referred to as layer-1 (L1) signaling), for example, by receiving DCI. Alternatively, the UE obtains the powerControlOffset by receiving medium-access-control-layer signaling (also referred to as layer-2 (L2) signaling). How to obtain the MCS table for receiving the PDSCH will be further described below.

### Method 1:

First, the UE obtains a mapping relationship between the powerControlOffset and the MCS table for receiving the PDSCH, by receiving signaling (e.g., higher-layer signaling). Then, the UE obtains the powerControlOffset by receiving physical-layer signaling or medium-access-control-layer signaling. Next, the UE obtains the MCS table for receiving the PDSCH, according to the powerControlOffset and the mapping relationship between the powerControlOffset and the MCS table for receiving the PDSCH. Then, the UE receives the PDSCH according to the MCS parameters identified by the MCS table.

For example, by receiving the higher-layer signaling, the UE obtains the mapping relationship between the powerControlOffset and the MCS table for receiving the PDSCH, the mapping relationship being as shown in Table 10. By receiving the physical-layer signaling or medium-access-control-layer signaling, the UE obtains the powerControlOffset that is powerControlOffset-1. By using powerControlOffset-1, the UE identifies from Table 10 that the table used for identifying the CQI and corresponding to powerControlOffset-1 is Table 7. The UE receives the PDSCH according to the MCS parameters identified by Table 7.

TABLE 10
Mapping relationship between powerControlOffset
and MCS table for receiving PDSCH

| powerControlOffset | MCS table for receiving PDSCH |
|---|---|
| powerControlOffset-1 | Table 7 |
| powerControlOffset-2 | Table 8 |
| powerControlOffset-3 | Table 9 |

The advantage of using this method lies in that, it is possible to dynamically select an appropriate MCS to receive the PDSCH, without requiring additional signaling.

### Method 2:

First, the UE obtains a mapping relationship among the powerControlOffset indication information, the powerControlOffset and the MCS table for receiving the PDSCH, by receiving signaling (e.g., higher-layer signaling). Then, the UE obtains the powerControlOffset and the MCS table for receiving the PDSCH, by receiving physical-layer signaling or medium-access-control-layer signaling. Next, the UE obtains the MCS table for receiving the PDSCH, according to the powerControlOffset indication information and the mapping relationship among the powerControlOffset indication information, the powerControlOffset and the MCS table for receiving the PDSCH. Finally, the UE receives the PDSCH according to the MCS parameters identified by the MCS table.

For example, by receiving the higher-layer signaling, the UE obtains the mapping relationship among the powerControlOffset indication information, the powerControlOffset and the MCS table for receiving the PDSCH, the mapping relationship being as shown in Table 11. By receiving the physical-layer signaling, the UE obtains that the powerControlOffset indication information is “01.” By using the powerControlOffset indication information “01,” the UE identifies from Table 11 that the powerControlOffset is powerControlOffset-2 and the MCS table for receiving the PDSCH is Table 7. The UE receives the PDSCH according to the MCS parameters identified by Table 7.

TABLE 11
Mapping relationship among indication information,
powerControlOffset and MCS table for receiving PDSCH

| Indication | | MCS table for |
|---|---|---|
| information | powerControlOffset | receiving PDSCH |
| 00 | powerControlOffset-1 | Table 7 |
| 01 | powerControlOffset-2 | Table 7 |
| 10 | powerControlOffset-3 | Table 8 |

The advantage of using this method lies in that, it is possible to dynamically select an appropriate MCS to receive the PDSCH, without requiring additional signaling.

### Method 3:

First, the UE obtains the initial powerControlOffset and the initial MCS table for receiving the PDSCH, by receiving signaling (e.g., higher-layer signaling). Then, the UE obtains, by receiving the higher-layer signaling, the mapping relationship between a difference between the powerControlOffset and the new powerControlOffset and the MCS table for receiving a PDSCH, or the UE presets and obtains the mapping relationship. Then, the UE obtains the new powerControlOffset by receiving physical-layer signaling or medium-access-control-layer signaling. Next, the UE calculates the difference between the initial powerControlOffset and the new powerControlOffset. Then, the UE obtains the MCS table for receiving the PDSCH, according to the mapping relationship between the difference between the initial powerControlOffset and the new powerControlOffset and the MCS table for receiving the PDSCH. Finally, the UE receives the PDSCH according to the MCS parameters identified by the MCS table.

For example, by receiving the higher-layer signaling, the UE obtains the initial powerControlOffset-initial and the initial MCS table (Tables 7-9) for receiving the PDSCH. By receiving the higher-layer signaling, the UE obtains the mapping relationship between the difference between powerControlOffset-initial and powerControlOffset-new and the MCS table for receiving the PDSCH, the mapping relationship being as shown in Table 12. The UE obtains powerControlOffset-new by receiving the physical-layer signaling or medium-access-control-layer signaling. The UE calculates and obtains the difference m between powerControlOffset-initial and powerControlOffset-new, and a<m<=b. By using the difference m between powerControlOffset-initial and powerControlOffset-new, the UE identifies from Table 12 that the MCS table for receiving the PDSCH is Table 8. The UE receives the PDSCH according to the MCS parameters identified by Table 8.

TABLE 12
Mapping relationship between the difference and the MCS table

| Difference c between powerControlOffset- | MCS table for |
|---|---|
| initial and powerControlOffset-new | receiving PDSCH |
| c <= a | Table 9 |
| a < c <= b | Table 8 |
| b < c | Table 7 |

The advantage of using this method lies in that, it is possible to dynamically select an appropriate MCS to receive the PDSCH, without requiring additional signaling.

### Example 3

When receiving the powerControlOffset through the DCI, the UE lets the base station know whether the UE has received the powerControlOffset correctly. In this way, the understandings of the base station and the UE for the powerControlOffset for calculating the CQI are the same. The following methods may be used.

### Method 1:

When feeding back the CQI, the UE carries powerControlOffset-related information, which is used for indicating the powerControlOffset when the CQI is identified. Specifically, there are the following approaches.

### Approach 1:

After the UE receives the signaling (e.g., the signaling is DCI) indicating that the powerControlOffset is changed, and when the CQI is identified by applying the indicated powerControlOffset for the first time, the powerControlOffset indication information is added to the CSI for feeding back the CQI. For example, the powerControlOffset indication information in the CSI is of 1 bit. When the bit value is a specific value, it indicates that the CQI is a CQI identified by applying the changed powerControlOffset for the first time. For example, when the bit value is “1”, it indicates that the CQI is a CQI calculated by applying the changed powerControlOffset for the first time.

### Approach 2:

The PowerControlOffset indication information is added to the CSI containing the CQI and used for feeding back the CQI for each time, the powerControlOffset indication information being used to indicate whether the powerControlOffset used to identify the CQI is changed. The powerControlOffset indication information is added to the CSI for feeding back the CQI. For example, the powerControlOffset indication information in the CSI is of 1 bit. When the bit value is a specific value, it indicates that the CQI is a CQI identified by applying the changed powerControlOffset for the first time. For example, when the bit value is “1,” it indicates that the CQI is a CQI calculated by applying the changed powerControlOffset for the first time. When the bit value is a specific value, it indicates that the CQI is a CQI identified by applying the powerControlOffset that does not change. For example, when the bit value is “0”, it indicates that the CQI is a CQI identified by applying the powerControlOffset that is not changed.

### Approach 3:

The PowerControlOffset indication information is added to the CSI containing the CQI and used for feeding back the CQI for each time, the powerControlOffset indication information being used to indicate the powerControlOffset used to identify the CQI.

A scheme of indicating the powerControlOffset used to calculate the CQI refers to that, the UE receives higher-layer signaling to configure M powerControlOffset values or M powerControlOffset value combinations, and uses an L-bit or at least one block comprises at least one bit to indicate one powerControlOffset value or one powerControlOffset value combination in the M powerControlOffset values or M powerControlOffset value combinations, representing that the CQI in the CSI is calculated and obtained according to the indicated powerControlOffset value or powerControlOffset value combination.

### Method 2:

The HARQ-ACK (hybrid automatic repeat request acknowledgement) is fed back for the DCI indicating the powerControlOffset, and the PUCCH resource for transmitting the HARQ-ACK fed back for the DCI indicating the powerControlOffset should be determined. The PUCCH resource for transmitting the HARQ-ACK fed back for the DCI indicating the powerControlOffset is determined through the following approaches.

### Approach 1:

The UE receives independent higher-layer signaling to obtain the PUCCH resource for transmitting the HARQ-ACK fed back for the DCI indicating the powerControlOffset. This obtained PUCCH resource and the PUCCH resource for transmitting the HARQ-ACK of the PDSCH are independently configured, and the UE uses this obtained PUCCH resource to transmit the HARQ-ACK fed back for the DCI indicating the powerControlOffset.

By using this method, it is possible to configure the reasonable PUCCH resource for the transmission of the HARQ-ACK fed back for the DCI indicating the powerControlOffset. One of the method for configuring the PUCCH resource for the transmission of the HARQ-ACK fed back for the DCI indicating the powerControlOffset is as explained in FIG. 12.

### Approach 2:

The UE receives the PUCCH resource configured through higher-layer signaling and used for transmitting the HARQ-ACK of the PDSCH. The UE uses this PUCCH resource to transmit the HARQ-ACK fed back for the DCI indicating the powerControlOffset.

By using this method, it is possible to save the signaling of configuring the PUCCH resource for transmitting the HARQ-ACK fed back for the DCI indicating the powerControlOffset.

### Approach 3:

If the UE receives a PUCCH resource configured through independent higher-layer signaling and used for transmitting a HARQ-ACK fed back for the DCI indicating a powerControlOffset, the UE uses this PUCCH resource to transmit the HARQ-ACK fed back for the DCI indicating the powerControlOffset. If the UE does not receive the PUCCH resource configured through the independent higher-layer signaling and used for transmitting the HARQ-ACK fed back for the DCI indicating the powerControlOffset, the UE receives a PUCCH resource configured through higher-layer signaling and used for transmitting the HARQ-ACK of the PDSCH, and the UE uses the PUCCH resource configured through the higher-layer signaling and used for transmitting the HARQ-ACK of the PDSCH, to transmit the HARQ-ACK fed back for the DCI indicating the powerControlOffset.

It is possible to perform flexible processing using this method, thereby saving the signaling for configuring the PUCCH resource for transmitting the HARQ-ACK fed back for the DCI indicating the powerControlOffset, and making the configuration of the PUCCH resource for transmitting the HARQ-ACK fed back for the DCI indicating the powerControlOffset flexible and balanced.

When the HARQ-ACK fed back for the DCI indicating the powerControlOffset and the HARQ-ACK of the PDSCH are multiplexed on one PUCCH or PUSCH, the multiplexing can be performed using the following approaches.

### Approach 1:

First, the HARQ-ACK of the PDSCH scheduled by DCI and the HARQ-ACK of a semi-persistent (SPS) PDSCH are arranged into a sequence A={a1, a2, . . . , ak}. Then, a HARQ-ACK b fed back for the DCI indicating a powerControlOffset is arranged behind the sequence A of the HARQ-ACK of the PDSCH scheduled by the DCI and the HARQ-ACK of the semi-persistent (SPS) PDSCH, that is, the total HARQ-ACK sequence is {a1, a2, . . . , ak, b}. The advantage of this is to reduce the influence on the transmission of the HARQ-ACK of the PDSCH scheduled by the DCI and the HARQ-ACK of the semi-persistent (SPS) PDSCH due to the different understandings of the base station and the UE as to whether the HARQ-ACK fed back for the DCI indicating the powerControlOffset is multiplexed behind the sequence of the HARQ-ACK of the PDSCH scheduled by the DCI and the HARQ-ACK of the semi-persistent (SPS) PDSCH.

An other embodiment refers to that, the HARQ-ACK of the PDSCH scheduled by the DCI and the HARQ-ACK of the semi-persistent (SPS) PDSCH are first arranged into the sequence A={a1, a2, . . . , ak}, and then, the HARQ-ACK b fed back for the DCI indicating the powerControlOffset is arranged before the sequence A of the HARQ-ACK of the PDSCH scheduled by the DCI and the HARQ-ACK of the semi-persistent (SPS) PDSCH, that is, the total HARQ-ACK sequence is {b, a1, a2, . . . , ak}.

It can be assumed that the DCI indicating the powerControlOffset is common to a group, and thus, a plurality of UEs will receive the same indicator. At this time, the downlink assignment indicator (DAI) in the DCI cannot be sorted together with the DAI in the DCI scheduling the PDSCH. Thus, Approach 1 will be adopted.

### Approach 2:

The HARQ-ACK of the PDSCH scheduled by DCI and the HARQ-ACK fed back for the DCI indicating a powerControlOffset are sorted according to the DAIs in the DCI, to obtain a HARQ-ACK sequence. Then, the HARQ-ACK sequence of a semi-persistent (SPS) PDSCH is arranged behind the sequence of the HARQ-ACK of the PDSCH scheduled by the DCI and the HARQ-ACK fed back for the DCI indicating the powerControlOffset.

It can be assumed that the DCI indicating the powerControlOffset is unique to a UE, and thus, only one UE will receive this indicator. At this time, the downlink assignment indicator (DAI) in the DCI is sorted together with the DAI in the DCI scheduling the PDSCH. Thus, Approach 2 will be adopted.

In addition, an embodiment of the present disclosure further provides a user equipment (UE) in a wireless communication system. The user equipment (UE) in the wireless communication system comprises: a transceiver; and a processor, coupled to the transceiver and configured to perform the method performed by the user equipment (UE) in the wireless communication system according to any one of the above embodiments or examples. In embodiments or examples of the present disclosure, the user equipment (UE) may adopt the composition and structure in FIG. 3A.

In addition, an embodiment of the present disclosure further provides a method performed by a base station gNB in a wireless communication system. The method performed by the base station gNB in the wireless communication system comprises the following steps: transmitting information regarding a first mapping relationship to a user equipment (UE), wherein the first mapping relationship comprises a mapping relationship between first information and a CQI table for calculating a channel quality indicator (CQI), and the first information is information related to a power control offset (powerControlOffset); transmitting first indication information to the UE; and receiving CQI-related information from the UE, the CQI-related information being identified and obtained based on a CQI table determined according to the first indication information and the first mapping relationship.

In an embodiment of the present disclosure, the base station gNB may be any one of gNBs 101-103 in FIG. 1. In addition, an embodiment of the present disclosure further provides a method performed by a base station gNB in a wireless communication system. The method performed by the base station gNB in the wireless communication system comprises the following steps: transmitting information regarding a second mapping relationship to a user equipment (UE), wherein the second mapping relationship includes a mapping relationship between second information and a modulation and coding scheme (MCS) table, and the second information is information related to a power control offset (powerControlOffset); and transmitting second indication information to the UE, wherein at least one MCS parameter of a physical downlink shared channel (PDSCH) are identified based on an MCS table identified according to the second indication information and the second mapping relationship.

In an embodiment of the present disclosure, the base station gNB may be any one of gNBs 101-103 in FIG. 1. In addition, an embodiment of the present disclosure further provides a method performed by a base station gNB in a wireless communication system. The method performed by the base station gNB in the wireless communication system comprises the following steps: transmitting information related to a power control offset (powerControlOffset) to a user equipment (UE) through physical-layer signaling or medium-access-control-layer signaling; and receiving, from the UE, third indication information related to a power control offset used by the UE to identify a channel quality indicator (CQI).

In embodiments of the present disclosure, the base station gNB may be any one of gNBs 101-103 in FIG. 1. In addition, an embodiment of the present disclosure further provides a base station gNB in a wireless communication system. The base station gNB in the wireless communication system comprises: a transceiver; and a processor, coupled to the transceiver and configured to perform the method performed by the base station gNB in the wireless communication system according to any one of the above embodiments.

In embodiments of the present disclosure, the base station gNB may adopt the composition and structure in FIG. 3B.

The CQI reporting may be performed by combining the respective methods or operations disclosed in different embodiments. The at least one MCS parameter reporting may be performed by combining the respective methods or operations disclosed in different embodiments. The reporting of the indication information related to the power control offset may be performed by combining the respective methods or operations disclosed in different embodiments.

The specific embodiments described above do not constitute a limitation to the scope of protection of the present disclosure. It should be understood by those skilled in the art that various modifications, combinations, sub-combinations and substitutions may be made according to design requirements and other factors. Any modification, equivalent substitution and improvement made within the spirit and principle of the present disclosure shall be included within the scope of protection of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving information regarding a first mapping relationship, wherein the first mapping relationship includes a mapping relationship between first information and a channel quality indicator (CQI) table for identifying a CQI, and the first information is information related to a power control offset;
receiving first indication information;
identifying the CQI table based on the first indication information and the first mapping relationship; and
identifying the CQI according to the identified CQI table.

2. The method according to claim 1, wherein the first indication information is received through physical-layer signaling or medium-access-control-layer signaling.

3. The method according to claim 1, wherein the first mapping relationship further includes a mapping relationship between the power control offset and the CQI table, and
wherein the identifying of the CQI table comprises:
identifying a power control offset indicated by the first indication information; and
identifying a corresponding CQI table according to the identified power control offset and the first mapping relationship.

4. The method according to claim 1, wherein the first mapping relationship further includes a mapping relationship between a power control offset difference range and the CQI table,
wherein the method further comprises:
receiving information related to a reference power control offset, and
wherein the identifying of the CQI table comprises:
determining a difference between a power control offset indicated by the first indication information and the reference power control offset; and
identifying a corresponding CQI table based on the determined difference and the first mapping relationship.

5. The method according to claim 4, wherein the receiving of the information related to the reference power control offset comprises:
receiving the information related to the reference power control offset through higher-layer signaling; or
receiving information related to a plurality of power control offsets and indication information through the higher-layer signaling, the indication information being used to indicate the reference power control offset in the plurality of power control offsets; or
receiving information related to the plurality of power control offsets through the higher-layer signaling, wherein the reference power control offset is determined from the plurality of power control offsets based on a preset rule.

6. The method according to claim 1, wherein the first mapping relationship further includes a mapping relationship among indication information, the power control offset and the CQI table, and
wherein the identifying of the CQI table comprises:
identifying a power control offset and a CQI table corresponding to the first indication information based on the first indication information and the first mapping relationship.

7. A method performed by a user equipment (UE) in a wireless communication system, the method comprising:
receiving information regarding a second mapping relationship, wherein the second mapping relationship includes a mapping relationship between second information and a modulation and coding scheme (MCS) table, and the second information is information related to a power control offset (powerControlOffset);
receiving second indication information;
identifying an MCS table based on the second indication information and the second mapping relationship; and
identifying at least one MCS parameter of a physical downlink shared channel (PDSCH) based on the identified MCS table.

8. The method according to claim 7, wherein the second indication information is received through physical-layer signaling or medium-access-control layer signaling.

9. The method according to claim 7, wherein the second mapping relationship further includes a mapping relationship between the power control offset and the MCS table, and
wherein the identifying of the MCS table comprises:
identifying a power control offset indicated by the second indication information; and
identifying a corresponding MCS table based on the identified power control offset and the second mapping relationship.

10. The method according to claim 7, wherein the second mapping relationship further includes a mapping relationship between a power control offset difference range and the MCS table,
wherein the method further comprises:
receiving information related to a reference power control offset, and
wherein the identifying of the MCS table comprises:
identifying a difference between a power control offset indicated by the second indication information and the reference power control offset; and
identifying a corresponding MCS table based on the identified difference and the second mapping relationship.

11. The method according to claim 10, wherein the receiving of the information related to the reference power control offset comprises:
receiving the information related to the reference power control offset through higher-layer signaling; or
receiving information related to a plurality of power control offsets and indication information through the higher-layer signaling, the indication information being used to indicate the reference power control offset in the plurality of power control offsets; or
receiving the information related to the plurality of power control offsets through the higher-layer signaling, wherein the reference power control offset is determined from the plurality of power control offsets based on a preset rule.

12. The method according to claim 7, wherein the second mapping relationship further includes a mapping relationship among indication information, the power control offset, and the MCS table, and
wherein the identifying of the MCS table comprises:
identifying a power control offset and an MCS table corresponding to the second indication information based on the second indication information and the second mapping relationship.

13. A method performed by a user equipment (UE) in a wireless communication system, the method comprising:
receiving information related to a power control offset (powerControlOffset) through physical-layer signaling or medium-access-layer signaling; and
transmitting, to a base station, third indication information related to a power control offset used by the UE to identify a channel quality indicator (CQI).

14. The method according to claim 13, wherein the third indication information is transmitted through signaling of reporting, by the UE, CQI-related information to the base station.

15. The method according to claim 14,
wherein:
the third indication information is used to indicate whether the power control offset used by the UE to identify the CQI is changed, and:
the third indication information is transmitted through signaling of reporting the CQI-related information for first time after the power control offset used by the UE to identify the CQI is changed, or
the third indication information is transmitted through signaling of reporting the CQI-related information each time; or
wherein:
the third indication information is used to indicate the power control offset used by the UE to identify the CQI, and
the third indication information is transmitted through the signaling of reporting the CQI-related information each time.

16. The method according to claim 13, wherein the information related to the power control offset is received through downlink control information (DCI), and the third indication information is transmitted to the base station through a first hybrid automatic repeat request acknowledgement (HARQ-ACK).

17. The method according to claim 16, further comprising:
obtaining, through higher-layer signaling, a first physical uplink control channel (PUCCH) resource for transmitting the first HARQ-ACK, wherein the first HARQ-ACK is transmitted on the first PUCCH resource; or
obtaining, through the higher-layer signaling, a second PUCCH resource for transmitting a second HARQ-ACK of a physical downlink shared channel (PDSCH), wherein the first HARQ-ACK is transmitted on the second PUCCH resource.

18. The method according to claim 16, further comprising:
obtaining, through higher-layer signaling, a second PUCCH resource for transmitting a second HARQ-ACK of a physical downlink shared channel (PDSCH);
in case that a first PUCCH resource for transmitting the first HARQ-ACK is indicated through the higher-layer signaling, transmitting the first HARQ-ACK on the first PUCCH resource; and
in case that the first PUCCH resource for transmitting the first HARQ-ACK is not indicated through the higher-layer signaling, transmitting the first HARQ-ACK on the second PUCCH resource.

19. The method according to claim 18, wherein, if the first HARQ-ACK is transmitted on the second PUCCH resource, the first HARQ-ACK is arranged before or behind a sequence formed by arranging a HARQ-ACK of a PDSCH scheduled by the DCI and a HARQ-ACK of a semi-persistent (SPS) PDSCH, to form a total HARQ-ACK sequence, and the total HARQ-ACK sequence is transmitted on the second PUCCH resource, or
if the first HARQ-ACK is transmitted on the second PUCCH resource, the HARQ-ACK of the semi-persistent (SPS) PDSCH is arranged behind a sequence formed by arranging the HARQ-ACK of the PDSCH scheduled by the DCI and the first HARQ-ACK, to form a total HARQ-ACK sequence, and the total HARQ-ACK sequence is transmitted on the second PUCCH resource.

20. A user equipment (UE) in a wireless communication system, the user equipment comprising:
a transceiver; and
a processor coupled with the transceiver and configured to:
receive information regarding a first mapping relationship, wherein the first mapping relationship includes a mapping relationship between first information and a channel quality indicator (CQI) table for identifying a CQI, and the first information is information related to a power control offset;
receive first indication information;
identify the CQI table based on the first indication information and the first mapping relationship; and
identify the CQI according to the identified CQI table.
